(19) United States
(12) Patent Application Publication
(10) Pub. No.: US 2022/0125669 A1
(43) Pub. Date: Apr. 28, 2022

(54) MICRO-OUTER STABILIZER CONFIGURATION FOR DERMA ROLLER APPARATUS

(71) Applicant: Hillary Hayman, Los Angeles, CA (US)

(72) Inventor: Hillary Hayman, Los Angeles, CA (US)

(21) Appl. No.: 17/079,211

(22) Filed: Oct. 23, 2020

(51) Int. Cl. A61H 15/00

(52) U.S. Cl. CPC A61H 15/0092; A61H 2015/0007; A61H 2201/1253; A61H 2201/1695; A61H 2015/0042

(57) ABSTRACT

A derma roller apparatus has a handle, a first outer stabilizer, a second outer stabilizer, and a head connected to the handle via the first outer stabilizer and the second outer stabilizer. The head has an axial member positioned transverse to the handle. Furthermore, the head has a geometrically-shaped member positioned around the axial member in between the first outer stabilizer and the second outer stabilizer. The geometrically-shaped member has a diameter that progressively diminishes from a first end of the geometrically-shaped member to a second end of the geometrically-shaped member. Moreover, the first end of the geometrically-shaped member is proximal to the first outer stabilizer. The second end of the geometrically-shaped member is proximal to the second outer stabilizer. Finally, the derma roller apparatus has a plurality of needles situated around the geometrically-shaped member.

### BACKGROUND

### 1. Field

This disclosure generally relates to skincare apparatuses for the skin around the eyes and face of a user. More particularly, the disclosure relates to a micro-outer stabilizer configuration for a derma roller apparatus.

### 2. General Background

The skin around the eyes and face are often viewed as an early indicator of aging. Accordingly, the quest for youthful skin around the eyes has spawned many skincare products and treatments over the course of many centuries; these products and treatments range from non-invasive (e.g., topical eye creams) all the way to extremely invasive (e.g., plastic surgery). Yet, the efficacy of a particular product and treatment is not necessarily correlated to an increased level of invasiveness. In fact, invasive procedures, such as plastic surgery or dermatological procedures, sometimes lead to significant disfigurations.

Various apparatuses have been developed for at-home use to promote skincare rejuvenation around the eyes and on the face, but many of these apparatuses also have questionable efficacy. Furthermore, some of these apparatuses are difficult for users to use, specifically with respect to accessing hard-to-reach areas around the eyes. Moreover, most users are a bit apprehensive about any type of treatment near the eyes.

In particular, users are typically concerned about even the slightest bit of invasiveness around the eyes. In other words, safety is paramount. Yet, some apparatuses configured for home use do not provide enough durability to prevent breakage, thereby leading to safety concerns.

Ultimately, in current configurations, users wanting to have more dexterity and ease-of-use may have to accept some safety tradeoffs.

### SUMMARY

In one embodiment, a derma roller apparatus has a handle, a first outer stabilizer, a second outer stabilizer, and a head connected to the handle via the first outer stabilizer and the second outer stabilizer. The head has an axial member positioned transverse to the handle. Furthermore, the head has a geometrically-shaped member positioned around the axial member in between the first outer stabilizer and the second outer stabilizer. The geometrically-shaped member has a diameter that progressively diminishes from a center point of the geometrically-shaped member to a first end of the geometrically-shaped member and progressively diminishes from the center point of the geometrically-shaped member to a second end of the geometrically-shaped member. Moreover, the first end of the geometrically-shaped member is proximal to the first outer stabilizer. The second end of the geometrically-shaped member is proximal to the second outer stabilizer. Finally, the derma roller apparatus has a plurality of needles situated around the geometrically-shaped member.

In an alternative embodiment, the derma roller apparatus has a swivel configured to effectuate movement of the handle with respect to the head.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a micro-outer stabilizer configuration for a derma roller apparatus.

FIG. 2 illustrates a disassembly view of the derma roller apparatus illustrated in FIG. 1.

FIG. 3 illustrates the user being able to access hard-to-reach areas of the skin with the derma roller apparatus.

FIG. 4 illustrates the derma roller apparatus with a circular-shaped head.

FIG. 5 illustrates the user being able to access hard-to-reach areas, such as laugh lines, in proximity to the nose.

FIG. 6 illustrates a swivel that may be configured to effectuate movement of the handle with respect to the head.

FIG. 7 illustrates the user utilizing the derma roller apparatus illustrated in FIG. 6.

### DETAILED DESCRIPTION

A micro-outer stabilizer configuration is provided for a derma roller apparatus. The micro-outer stabilizer configuration may be utilized for a variety of derma rollers, particularly with respect to eye derma rollers and face derma rollers. The term outer stabilizer connotes a member that connects a handle to a portion of an axial member, whereby the outer stabilizer is outside of the wingspan of the head of the derma roller. Furthermore, the term micro-outer stabilizer refers to an outer stabilizer that has a relatively small thickness (e.g., in the approximate range of one to three millimeters). A stabilizer stabilizes a head during motion of a handle of the derma roller such that the needles positioned around the head are substantially confined to rotational movement around the head during application of the derma roller to the skin, rather than other movements such as transverse movements in unintended directions.

In contrast with previous configurations, the micro-outer stabilizer configuration provides access to hard-to-reach areas around the eyes and on the face. The micro-outer stabilizers stabilize the head of the derma roller with respect to the handle, but also allow for access by needles situated around the derma roller head to hard-to-reach areas, which was previously difficult to obtain via outer stabilizers positioned outside the wingspan of the derma roller head that were relatively thick. In essence, previous configurations had outer stabilizers that blocked the derma roller needles from puncturing hard-to-reach areas of the skin (e.g., by the corners of the eyes, edges of the nose, etc.). In addition to the micro-outer stabilizers, the derma roller apparatus provided for herein utilizes a head with curvature to allow for easier access to curved areas and crevices on portions of the face, and around the eyes, of the user. As a result, the derma roller apparatus with micro-outer stabilizers allows for improved collagen production in the eye area and the face area of a user, thereby providing the potential for improved skincare rejuvenation to help reduce or eliminate eye skin conditions such as crow's feet, dark circles, laugh lines, etc.

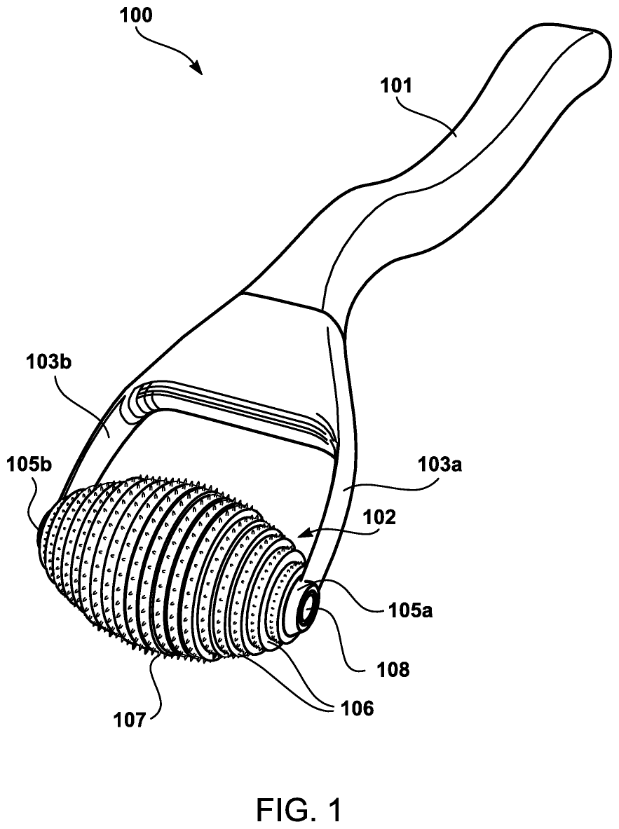

FIG. 1 illustrates a micro-outer stabilizer configuration for a derma roller apparatus 100. As opposed to having obstructive outer stabilizers, the derma roller apparatus 100 has a first outer stabilizer 103a (e.g., right outer stabilizer) and a second outer stabilizer 103b (e.g., left outer stabilizer) that have a relatively low thickness (e.g., approximately one half millimeter to three millimeters). Given that the range provided for herein is provided only as an example, the thickness of the outer stabilizers 103a and 103b may vary. For instance, the outer stabilizers may be even thinner than one half millimeter, or potentially greater than three millimeters, so long as the outer stabilizers 103a and 103b provide little to no obstruction to the hard-to-reach areas. The thickness is measured transverse to the handle 101 and parallel to the axial member.

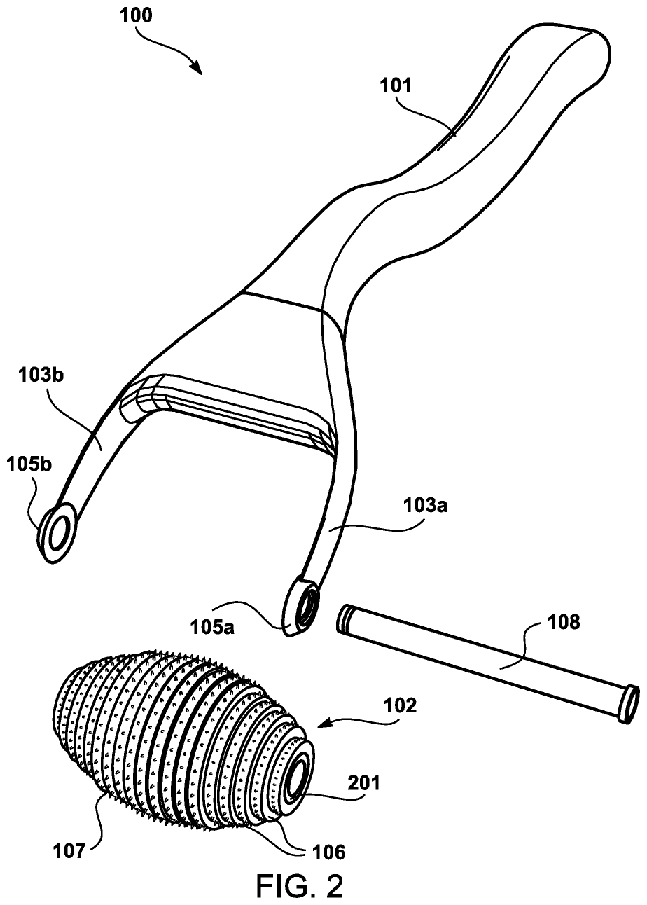

The derma roller apparatus 100 also has a geometrically-shaped member 102 that is positioned around the axial member 108, which is depicted in a disassembly view of the derma roller apparatus illustrated by FIG. 2. Endcaps 105a and 105b may be utilized to maintain the geometrically-shaped member 102 on the axial member 108. For example, the axial member 108 may be positioned through a bearing 201 of the geometrically-shaped member 102. (The phrase geometrically-shaped member is intended to include individual members (e.g., a single disc-shaped member) or a group of members (e.g., multiple discs).)

In one embodiment, the geometrically-shaped member 102 has a diameter that progressively diminishes from a center point of the geometrically-shaped member 102 to a first end of the geometrically-shaped member 102, and progressively diminishes from the center point of the geometrically-shaped member 102 to a second end of the geometrically-shaped member 102, whereby the first end of the geometrically-shaped member 102 is proximal to the first outer stabilizer 103a, and the second end of the geometrically-shaped member 102 is proximal to the second outer stabilizer 103b. As an example, the geometrically-shaped member 102 may be substantially shaped in the form of an ellipsoid, as illustrated in FIGS. 1 and 2.

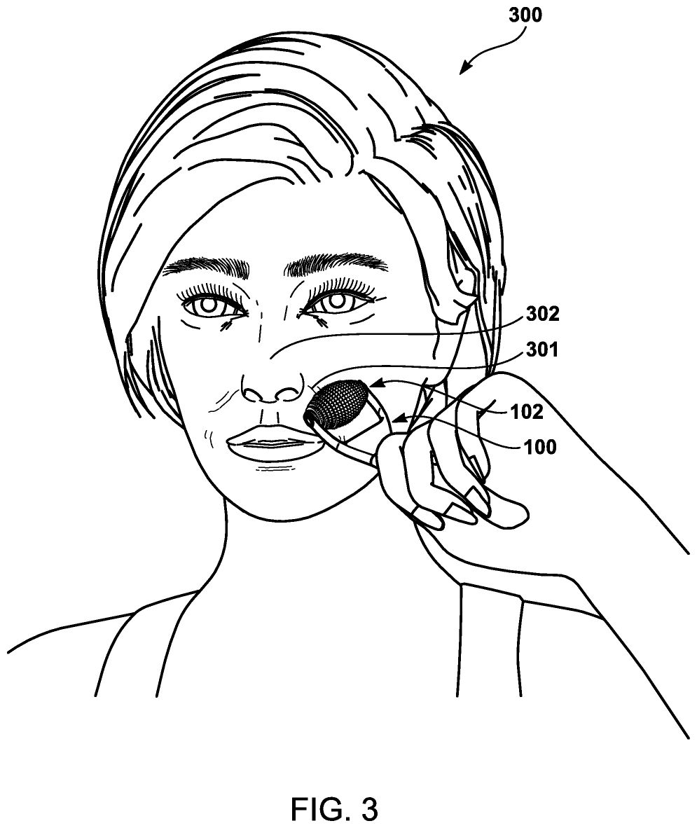

As a result of the geometrically-shaped head 102 and the micro-outer stabilizers 103a and 103b, the user 300 is able to access hard-to-reach areas of the skin, such as a laugh line 301 in proximity to the nose 302, with the derma roller apparatus 100, as illustrated in FIG. 3.

Accordingly, the derma roller apparatus 100 may be optimized for convenient access to the skin around the eyes or wrinkles by the nose 302 of the user 300. In other words, the derma roller apparatus 100 may be constructed according to varying widths most suitable for a particular function. For example, the derma roller apparatus 100 may be constructed to have a width of the head in the approximate range of one quarter inch and one inch, thereby being an eye derma roller apparatus. As another example, the derma roller apparatus 100 may be constructed to have a width of the head in the approximate range of one half inch and two inches, thereby being a face derma roller. (The ranges provided for herein are examples—slight variations (e.g., within zero to twenty percent) may be utilized instead.)

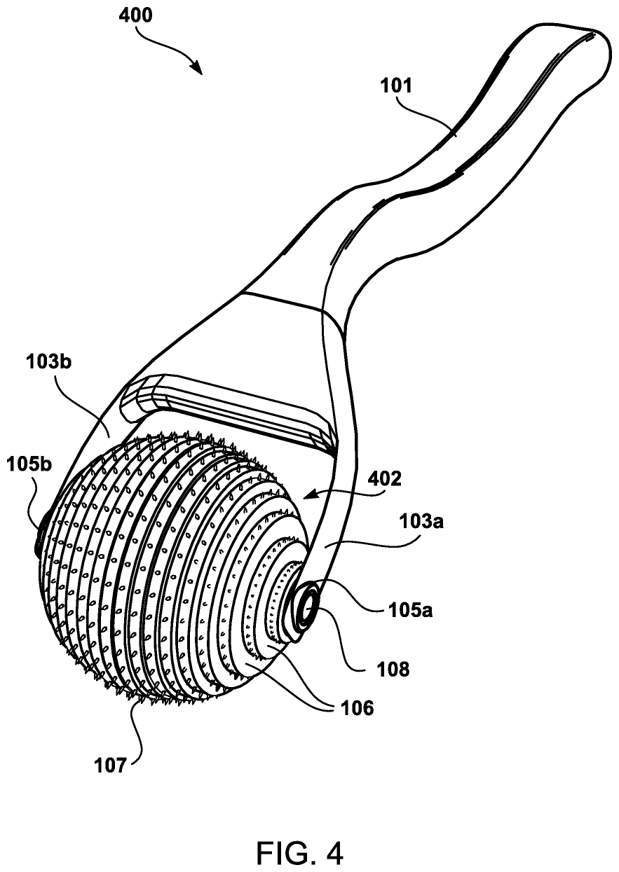

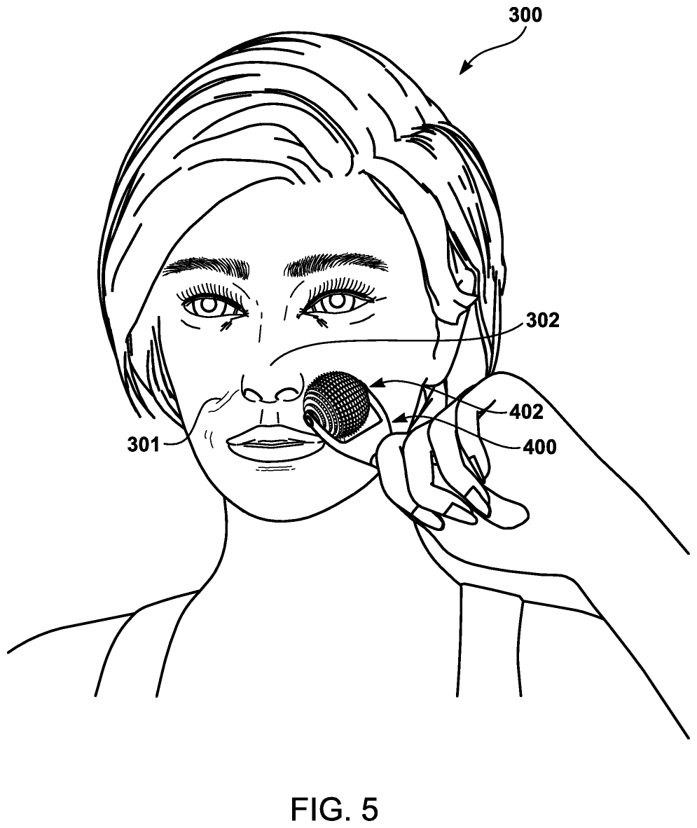

FIG. 4 illustrates the derma roller apparatus 400 with a spherical-shaped head 402. In essence, the spherical-shaped head 402 allows for the derma roller apparatus 400 to access more hard-to-reach areas of the skin, given the increased amount of curvature. As an example, the user 300 is able to access hard-to-reach areas, such as laugh lines 301, in proximity to the nose 302, as illustrated in FIG. 5.

Although examples of geometrically-shaped members that are substantially elliptical and substantially spherical are illustrated, the geometrically-shaped members may have other geometric shapes. (When utilized in conjunction with a shape, the term “substantial” is intended to connote a shape as perceived by a human.)

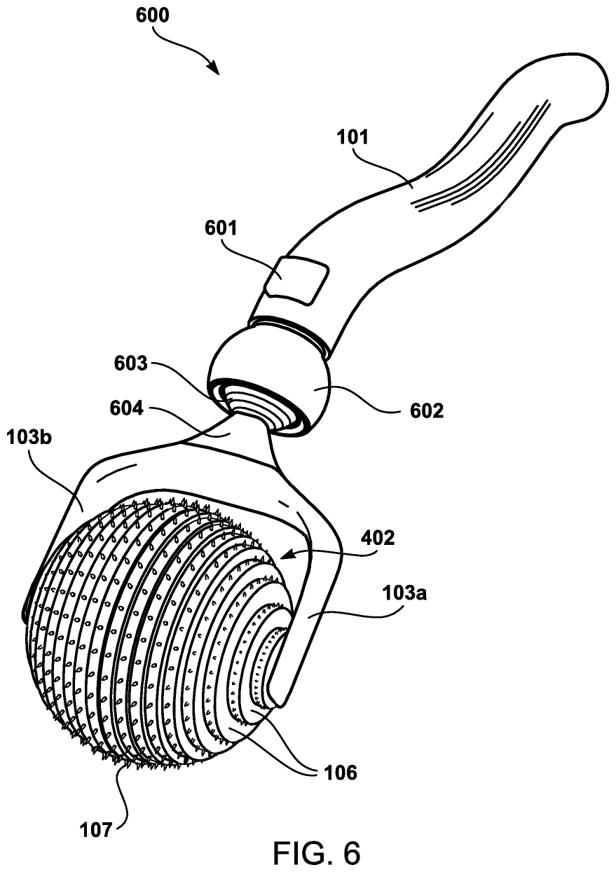

Although the previous embodiments were illustrated as having the handle 101 fixed with respect to the head 102 or the head 402, in an alternative embodiment illustrated in FIG. 6, a swivel 604 may be configured to effectuate movement of the handle 101 with respect to the head 402 of the derma roller apparatus 600. (Alternatively, the swivel 604 may be utilized with the head 102 or a head with a different geometrical shape configuration.)

As an example, the swivel 604 is illustrated as having a ball and socket configuration. For instance, a ball 603 may be inserted into a socket within an outer housing 602 connected to the handle 101. As a result, the swivel 604 allows for free range movement (e.g., three hundred sixty degrees movement). In essence, the head 402 may be adjusted along a single axis (e.g., yaw, pitch, or roll), or along multiple axes (e.g., yaw, pitch, and roll). In an alternative embodiment, a different swivel configuration, other than a ball and socket, may be utilized to restrict movement along one particular axis (e.g., yaw, pitch, and roll).

Furthermore, the swivel configuration may have a locking mechanism that may be activated, such as via an actuator 601 (e.g., button). For instance, the ball 603 may have ribs or grooves that interface with an inner prong connected to the actuator 601. (Alternatively, the ball may not be ribbed or have grooves. Other types of locking configurations (e.g., spring-loaded, magnetic, etc.) may be utilized, and the actuator 601 may be utilized with those alternative configurations.)

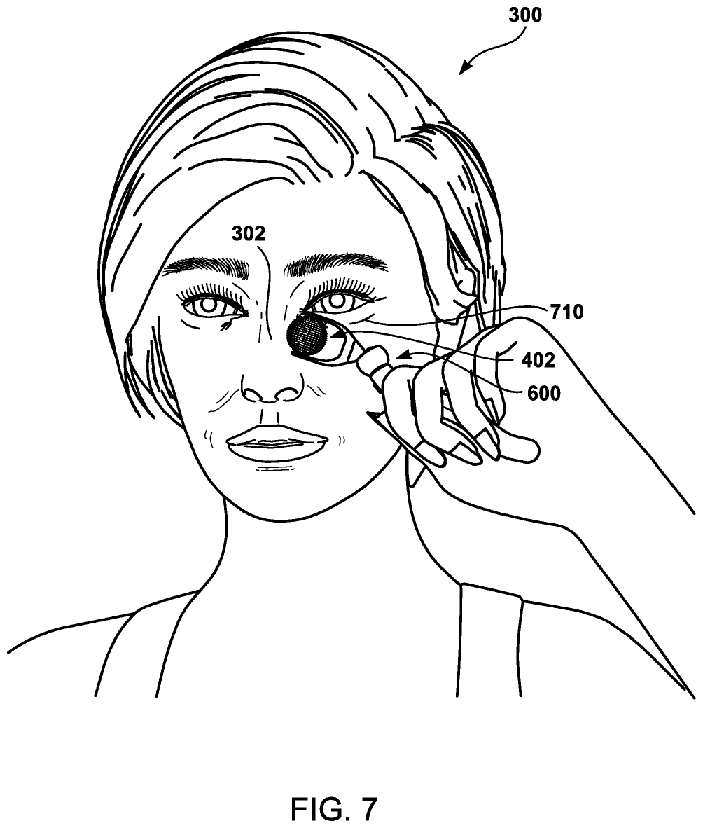

FIG. 7 illustrates the user 300 utilizing the derma roller apparatus 600 illustrated in FIG. 6. In particular, the user 700 is able to utilize the derma roller apparatus 600 as an eye derma roller. For example the user 300 may move the derma roller apparatus 600 with respect to crow's feet 710 by an edge of the nose 302. The user 300 is able to adjust the angle of the head 402 to access the hard-to-reach edge by the nose 710, which could be quite difficult if a thick outer stabilizer and head without curvature were present. (Other types of derma rollers with restricted access to different axes may be utilized instead.)

It is understood that the processes, systems, and apparatuses described herein may also be applied in other types of processes, systems, and apparatuses. Those skilled in the art will appreciate that the various adaptations and modifications of the embodiments of the processes, systems, and apparatuses described herein may be configured without departing from the scope and spirit of the present processes and systems. Therefore, it is to be understood that, within the scope of the appended claims, the present processes, systems, and apparatuses may be practiced other than as specifically described herein.

I claim:

1. A derma roller apparatus comprising:
a handle;
a first outer stabilizer;
a second outer stabilizer; and
a head connected to the handle via the first outer stabilizer and the second outer stabilizer, the head comprising:
an axial member positioned transverse to the handle,
a geometrically-shaped member positioned around the axial member in between the first outer stabilizer and the second outer stabilizer, the geometrically-shaped member having a diameter that progressively diminishes from a center point of the geometrically-shaped member to a first end of the geometrically-shaped member and progressively diminishes from a center point of the geometrically-shaped member to a second end of the geometrically-shaped member, the first end of the geometrically-shaped member being proximal to the first outer stabilizer, the second end of the geometrically-shaped member being proximal to the second outer stabilizer, and
a plurality of needles situated around the geometrically-shaped member.

2. The derma roller apparatus of claim 1, wherein each of the first outer stabilizer and the second outer stabilizer connects to a corresponding portion of the axial member that is outside of a width of the axial member.

3. The derma roller apparatus of claim 1, wherein a thickness of each of the first outer stabilizer and the second outer stabilizer is within a range of one half millimeter to three millimeters, the thickness being measured transverse to the handle and parallel to the axial member.

4. The derma roller apparatus of claim 1, wherein the head has an elliptical shape.

5. The derma roller apparatus of claim 1, wherein the head has a spherical shape.

6. The derma roller apparatus of claim 1, wherein the handle is fixed with respect to the head via the first outer stabilizer and the second outer stabilizer.

7. The derma roller apparatus of claim 1, further comprising a swivel that is configured to effectuate movement of the handle with respect to the head.

8. The derma roller apparatus of claim 7, further comprising a locking mechanism that restricts the swivel from movement at an angle between the head and the handle.

9. The derma roller apparatus of claim 8, wherein the handle comprises an actuator that activates the locking mechanism.

10. The derma roller apparatus of claim 9, wherein the swivel connects the handle to the first outer stabilizer and the second outer stabilizer.

11. The derma roller apparatus of claim 10, wherein the swivel is a ball and socket mechanism that is configured to move the handle along multiple axes with respect to the head.

12. The derma roller apparatus of claim 10, wherein the swivel is configured to rotate the handle only about a yaw axis with respect to the head without rotation about a pitch axis and a roll axis.

13. The derma roller apparatus of claim 10, wherein the swivel is configured to rotate the handle only about a pitch axis with respect to the head without rotation about a yaw axis and a roll axis.

14. The derma roller apparatus of claim 10, wherein the swivel is configured to rotate the handle only about a roll axis with respect to the head without rotation about a pitch axis and a yaw axis.

15. The derma roller apparatus of claim 1, wherein a width of the head is in an eye derma roller specific range between one quarter inch and one inch.

16. The derma roller apparatus of claim 1, wherein a width of the head is in a face derma roller specific range between one half inch and two inches.

17. The derma roller apparatus of claim 1, wherein each of the first plurality of needles has a length in a range of twenty-five tenths millimeters to two and one half millimeters.

18. A derma roller apparatus comprising:
a handle;
a first outer stabilizer;
a second outer stabilizer;
a head connected to the handle via the first outer stabilizer and the second outer stabilizer, the head comprising:
an axial member positioned transverse to the handle,
a geometrically-shaped member positioned around the axial member in between the first outer stabilizer and the second outer stabilizer, the geometrically-shaped member having a diameter that progressively diminishes from a center point of the geometrically-shaped member to a first end of the geometrically-shaped member and progressively diminishes from a center point of the geometrically-shaped member to a second end of the geometrically-shaped member, the first end of the geometrically-shaped member being proximal to the first outer stabilizer, the second end of the geometrically-shaped member being proximal to the second outer stabilizer, and
a plurality of needles situated around the geometrically-shaped member; and
a swivel configured to effectuate movement of the handle with respect to the head.

19. The derma roller apparatus of claim 18, further comprising a locking mechanism that restricts the swivel from movement at an angle between the head and the handle.

20. The derma roller apparatus of claim 19, wherein the handle comprises an actuator that activates the locking mechanism.
